(19) United States
(12) Patent Application Publication
(10) Pub. No.: US 2017/0262367 A1
(43) Pub. Date: Sep. 14, 2017

(54) MULTI-RANK COLLISION REDUCTION IN A HYBRID PARALLEL-SERIAL MEMORY SYSTEM

(71) Applicant: QUALCOMM INCORPORATED, SAN DIEGO, CA (US)

(72) Inventors: DEXTER TAMIO CHUN, SAN DIEGO, CA (US); YANRU LI, SAN DIEGO, CA (US); JAVID JAFFARI, SAN DIEGO, CA (US); AMIN ANSARI, SAN DIEGO, CA (US)

(21) Appl. No.: 15/068,184

(22) Filed: Mar. 11, 2016

(51) Int. Cl. G06F 12/08

(52) U.S. Cl. CPC G06F 12/0802; G06F 2212/1024; G06F 2212/152; G06F 2212/657

(57) ABSTRACT

Systems, methods, and computer programs are disclosed for allocating memory in a hybrid parallel/serial memory system. One method comprises configuring a memory address map for a multi-rank memory system with a dedicated serial access region in a first memory rank and a dedicated parallel access region in a second memory rank. A request is received for a virtual memory page. If the request comprises a performance hint, the virtual memory page is selectively assigned to a free physical page in the dedicated serial access in the first memory rank and the dedicated parallel access region in the second memory rank.

### DESCRIPTION OF THE RELATED ART

Portable computing devices (e.g., cellular telephones, smart phones, tablet computers, portable digital assistants (PDAs), portable game consoles, wearable devices, and other battery-powered devices) and other computing devices continue to offer an ever-expanding array of features and services, and provide users with unprecedented levels of access to information, resources, and communications. To keep pace with these service enhancements, such devices have become more powerful and more complex. Portable computing devices now commonly include a system on chip (SoC) comprising various memory clients embedded on a single substrate (e.g., one or more central processing units (CPUs), a graphics processing unit (GPU), digital signal processors, etc.). The memory clients may request read and write transactions from a memory system.

The SoC may be electrically coupled to the memory system by both a parallel access channel and a separate serial channel. Hybrid parallel-serial memory access can provide increased bandwidth without an increased cost and number of pins required to increase bandwidth through parallel memory access channels. In such systems, however, memory is randomly allocated across physical addresses associated with the serial and parallel access channels, which can result in inefficient memory traffic access. This inefficiency can be worsened due to physical memory fragmentation. Furthermore, memory collisions may occur between the serial and parallel access channels.

Accordingly, there is a need for improved systems and methods for allocating memory in a hybrid parallel-serial memory system.

### SUMMARY OF THE DISCLOSURE

Systems, methods, and computer programs are disclosed for allocating memory in a hybrid parallel/serial memory system. One method comprises configuring a memory address map for a multi-rank memory system with a dedicated serial access region in a first memory rank and a dedicated parallel access region in a second memory rank. A request is received for a virtual memory page. If the request comprises a performance hint, the virtual memory page is selectively assigned to a free physical page in the dedicated serial access in the first memory rank and the dedicated parallel access region in the second memory rank.

Another embodiment is a system for allocating memory in a hybrid parallel/serial memory system. The system comprises a multi-rank memory system electrically coupled to a system on chip (SoC) via a serial bus and a parallel bus. The multi-rank memory system comprises a first memory rank and a second memory rank. The SoC comprises a memory allocator configured to: receive a request for a virtual memory page; and if the request comprises a performance hint, selectively allocate the virtual memory page to a free physical page in a dedicated serial access region in the first memory rank and a dedicated parallel access region in the second memory rank.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of an embodiment of a system for allocating memory in a multi-rank memory system having hybrid parallel-serial access.

FIG. 2 is a combined block/flow diagram illustrating an embodiment of a multi-rank dual inline memory module (DIMM).

FIG. 3 is a data diagram illustrating an exemplary memory address map for the multi-rank DIMM of FIG. 2.

FIG. 4 is a flowchart illustrating an embodiment of a method for allocating memory in a multi-rank memory system having hybrid parallel-serial access.

FIG. 5 is a data diagram illustrating an exemplary flag structure for providing a performance hint to the memory allocator in FIG. 1.

FIG. 6 is data diagram the memory address map of FIG. 3 for providing multiple channels.

FIG. 7 is a block diagram of an embodiment of a portable communication device for incorporating the system of FIG. 1.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone”, “wireless communication device,” and “wireless handset” are used interchangeably. With the advent of third generation (“3G”) wireless technology and four generation (“4G”), greater bandwidth availability has enabled more portable computing devices with a greater variety of wireless capabilities. Therefore, a portable computing device may include a cellular telephone, a pager, a PDA, a smartphone, a navigation device, or a hand-held computer with a wireless connection or link.

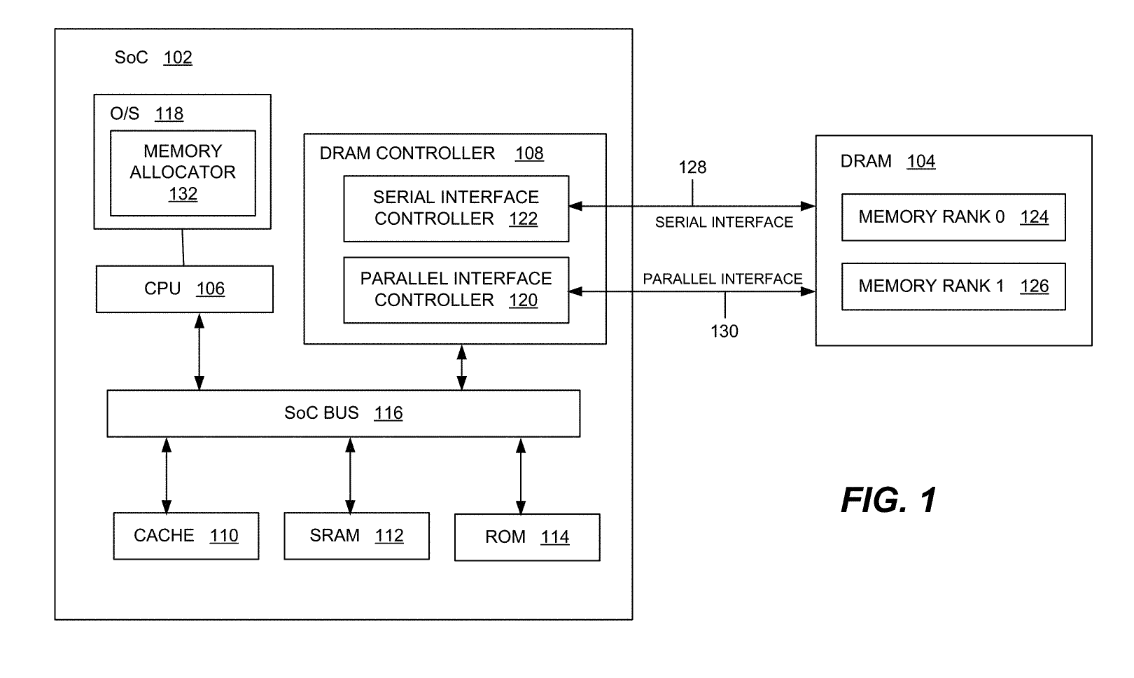

FIG. 1 illustrates an embodiment of a system 100 for providing hybrid parallel-serial memory access to a multi-rank memory system. The system 100 may be implemented in any computing device, including a personal computer, a workstation, a server, or a portable computing device (PCD), such as a cellular telephone, a smart phone, a portable digital assistant (PDA), a portable game console, a tablet computer, or a battery-powered wearable device.

As illustrated in the embodiment of FIG. 1, the system 100 comprises a system on chip (SoC) 102 electrically coupled to a multi-rank memory system. The multi-rank memory system comprises two or more memory ranks. In the embodiment of FIG. 1, a dynamic random access memory (DRAM) system 104 comprises a first memory rank 124 (rank 0) and a second memory rank 126 (rank 1). Each of memory ranks 124 and 126 may comprise a set of DRAM chips on a separate die and connected to the same chip select. For example, memory rank 124 may be mounted on a first side of a printed circuit board (PCB), and memory rank 126 may be mounted on a second side of the PCB.

As illustrated in FIG. 1, the multi-rank memory system 104 is electrically coupled to the SoC 102 by both a parallel interface 130 and a serial interface 128 to provide hybrid parallel-serial memory access. The parallel interface 130 provides one or more parallel access channels. Data is transferred with multiple bits sent simultaneously over the parallel access channels (wires, frequency channels) within the same cable, or radio path, and synchronized to a clock. A variety of standards, protocols, or technologies may be used to perform the parallel transfer of the data, such as transfers to (or from) a double data rate synchronous dynamic random-access memory (DDR SDRAM) using the DDR4-2400 DDR4 standard (DDR4). Parallel access channels, such as DDR4, may provide various desirable characteristics including significantly lower latency.

The serial interface 128 provides one or more serial access channels that may be used to communicate data between the SoC 102 and the multi-rank memory system 104. A variety of standards, protocols, or technologies may be used to perform the serial transfer of the data. In an embodiment, the serial access channels may comprise a direct memory access (DMA) channel, such as, for example, a peripheral component interconnection express (PCIe) channel. As known in the art, a PCIe channel provides various desirable characteristics, such as, higher maximum system bus throughput, lower I/O pin count, less complexity in maintaining signal integrity, and a smaller physical footprint. However, PCIe is typically not used for system memory access because of the significantly greater initial setup latency required to transfer a given block of data between over the single channel. The latency of serial access channels, such as PCIe, can be significantly greater than the latency of parallel access channels, such as DDR4.

The SoC 102 comprises various on-chip components, including one or more memory clients, a DRAM controller 108, a cache 110, a static random access memory (SRAM) 112, and a read only memory (ROM) 114 interconnected via a SoC bus 116. The memory clients request memory resources (read and/or write requests) from the multi-rank memory system 104. The memory clients may comprise one or more processing units (e.g., central processing unit (CPU) 106, a graphics processing unit (GPU), digital signal processor (DSP), etc.), a video encoder, or other clients requesting read/write access to the memory system.

The DRAM controller 108 may comprise a serial interface controller 122 and a parallel interface controller 120. The serial interface controller 122 controls the data transfer over one or more serial channels (serial interface 128). The parallel controller 120 controls the data transfer over one or more lanes of the parallel interface 130.

The system 100 further comprises a kernel memory allocator 132 of a high-level operating system (HLOS) 118. The memory allocator 132 comprises the logic and/or functionality for controlling allocation of memory to the memory ranks 124 and 126 in the multi-rank DRAM 104. As described below in more detail, the multi-rank DRAM 104 is partitioned into dedicated memory regions for providing serial access, parallel access, and hybrid parallel-serial access based on physical addresses with the serial access address range and the parallel access address range on different DRAM dies. The memory allocator 132 steers memory buffer allocation requests toward physical addresses at the different dedicated regions according to a memory bandwidth preference to optimize power and/or bandwidth of DRAM access. When requesting virtual memory page(s), a process may specify a “hint” to the memory allocator 132. When memory bandwidth performance is preferred or requested, the memory allocator 132 may fairly spread these “performance” requests across a dedicated serial access region in a first memory rank 124 and a dedicated parallel access region 126 in a second memory rank 126. In this manner, simultaneous memory access may be provided via the serial interface 128 and the parallel interface 130. When memory performance is not a factor, the memory allocator 132 may use dedicated parallel regions on either the memory rank 124 or the memory rank 126.

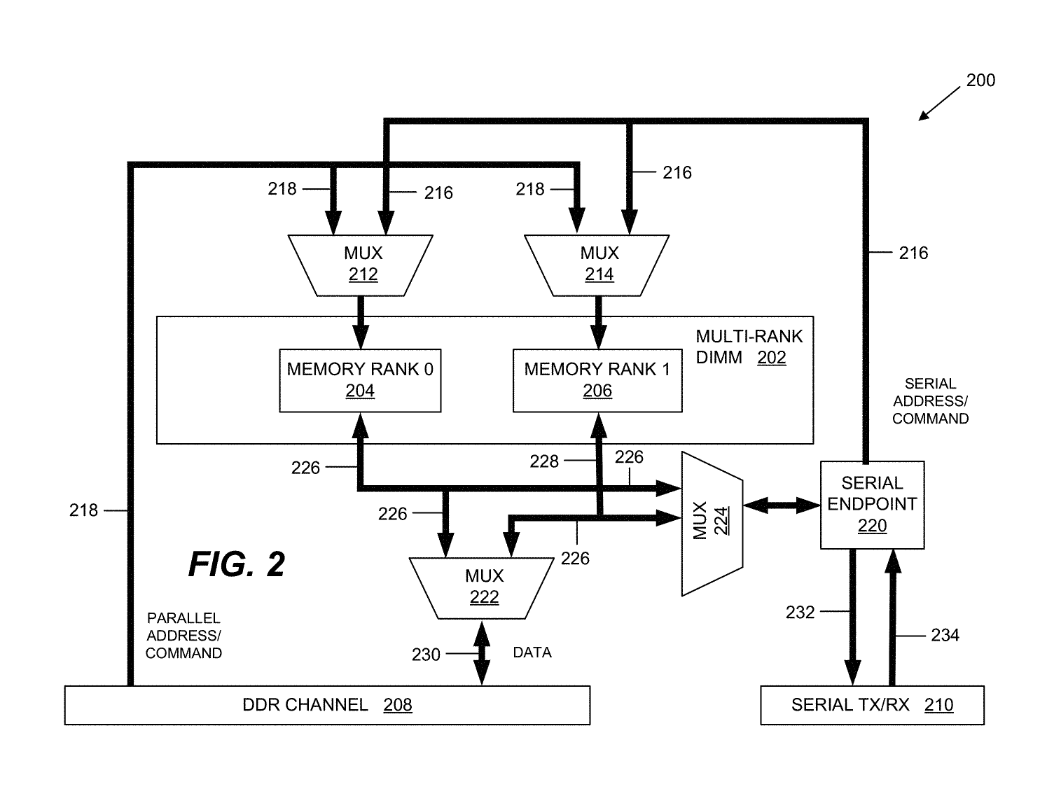

FIG. 2 illustrates an embodiment in which the multi-rank DRAM 104 comprises a dual inline memory module (DIMM) 202. Memory ranks 204 and 206 may be mounted on opposing sides of a printed circuit board (PCB) or otherwise stacked. Each memory rank has address/commands and data interfaces. The address/commands mux logic 212 receives address/commands either from serial endpoint 220 via bus 216, or from parallel DDR channel 208 via bus 218, during a particular operation period. The address/commands mux logic 212 then passes the address/commands to the memory rank0. The data interface 226 on memory rank 0 is connected to both parallel DDR channel via data mux logic 222, and serial endpoint 220 via data mux logic 224. The data mux logic 222 only inputs/outputs data 230 for the corresponding address/command that the DDR channel 208 sent via bus 218. The data mux logic 224 only inputs/outputs data for the corresponding address/command that the serial endpoint sent via bus 216.

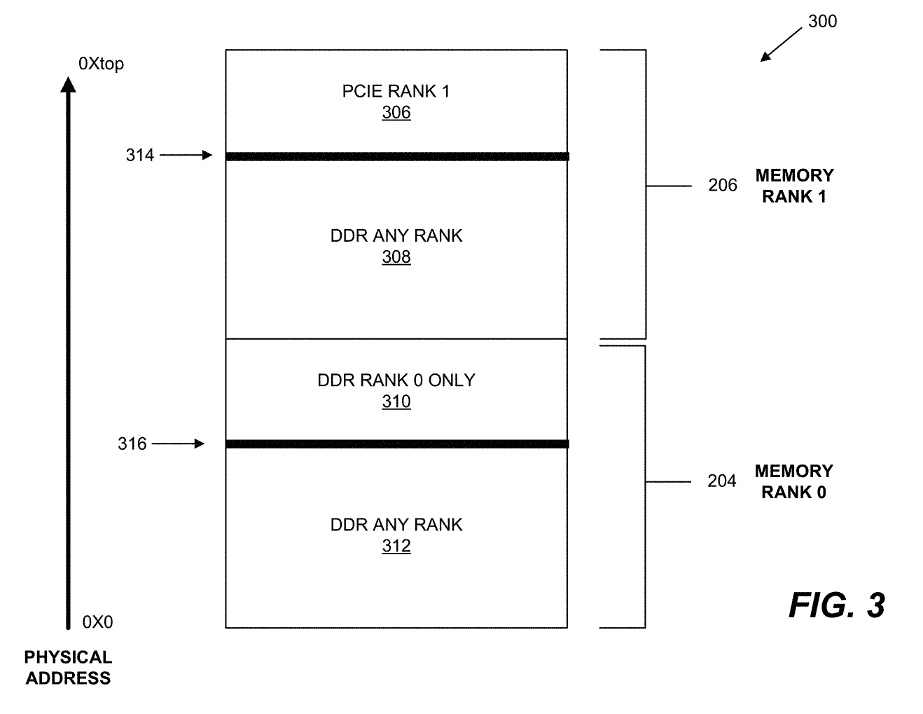

FIG. 3 illustrates an exemplary memory address map 300 for the multi-rank DIMM 202. Memory rank 206 (rank 1) is partitioned into a first region 306 dedicated to rank 1 serial access and a second region 308 dedicated to any rank parallel access. Memory rank 204 (rank 0) is partitioned into a third region 310 dedicated to rank 0 parallel access and a fourth region 312 dedicated to any rank parallel access. As illustrated in FIG. 3, the first region 306 may have a dynamic boundary 314 for adjusting the size of regions 306 and 308 in memory rank 206. The third region 310 may have a dynamic boundary 316 for adjusting the size of regions 310 and 312 in memory rank 204.

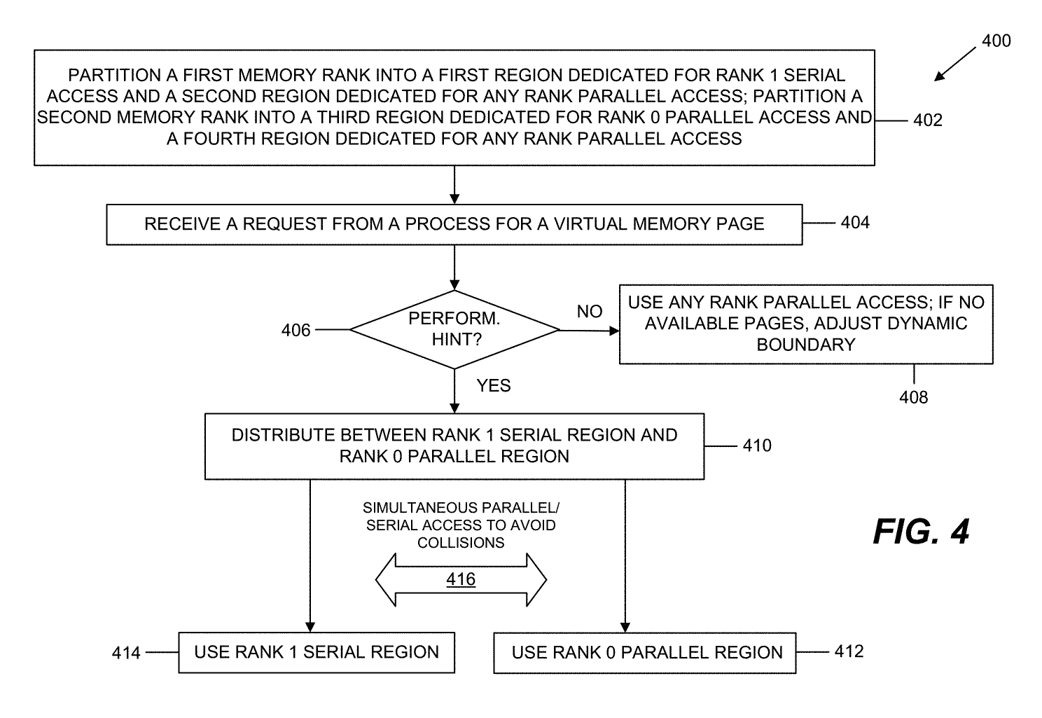

FIG. 4 is a flowchart illustrating an embodiment of a method 400 for allocating memory requests according to the memory address map 300. At block 402, memory ranks 206 and 204 may be partitioned as illustrated in FIG. 3 for hybrid parallel-serial memory access. At block 404, the memory allocator 132 receives a request from a process executing on CPU 106 for a virtual memory page (4 Kbyte page). The request may comprise a hint for indicating a preference for memory bandwidth performance. Processes needing higher performance may include, for example, gaming, image processing, or data computation with a high degree of precision, with a high number of data points/resolution, and or being repeatedly recalculated/refreshed at a very high refresh rate. For example, a virtual reality game may require very accurate color depth, a very large amount of pixels, and the display must be refreshed rapidly, leading to high memory bandwidth.

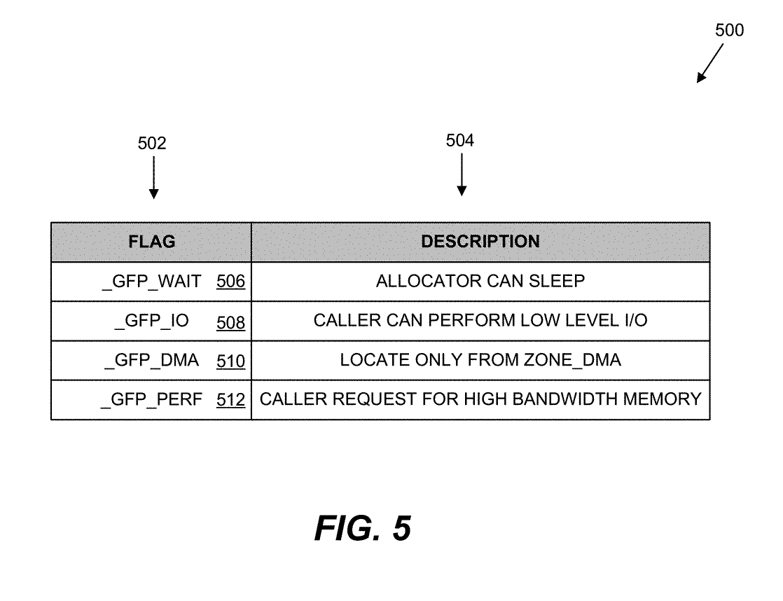

FIG. 5 is table 500 illustrating an exemplary flag structure 500 for providing a performance hint to the memory allocator 132. Column 502 lists flags 506, 508, 510, and 512 that may be specified in a request to memory allocator 132. A “_GFP_WAIT” flag 506 may be used to indicate that the memory allocator 132 may enter a sleep mode. A “_GFP_IO” flag 508 may be used to indicate a preference for low level bandwidth. A “_GFP_DMA” flag 510 may be used to indicate a preference for direct memory access. A “_GFP_PERF” flag 512 may be used to indicate the performance hint (i.e., a preference for high bandwidth memory) to the memory allocator 132.

Referring again to FIG. 4, at decision block 406, the memory allocator 132 may determine whether a performance hint has been specified in the received request. If the request does not comprise a performance hint, at block 408, the memory allocator 132 may use any rank parallel access (e.g., region 308 in memory rank 206 or region 312 in memory rank 204). If the corresponding region does not have any free physical pages, the dynamic boundary 314 and/or 316 may be adjusted to increase the size of the region 308/312 and correspondingly decrease the size of the region 306 and 310, respectively. If the request comprises a performance hint, at block 410, the memory allocator 132 may selectively assign the virtual memory page to a free physical page in the dedicated serial access region 306 (memory rank 206) and the dedicated parallel access region 310 (memory rank 204). In an embodiment, the memory allocator 132 may alternative between the dedicated serial access region 306 (block 414) and the dedicated parallel access region 310 (block 412). In this manner, as illustrated at arrow 416, the memory allocator 132 may simultaneously provide parallel and serial access to avoid memory collisions.

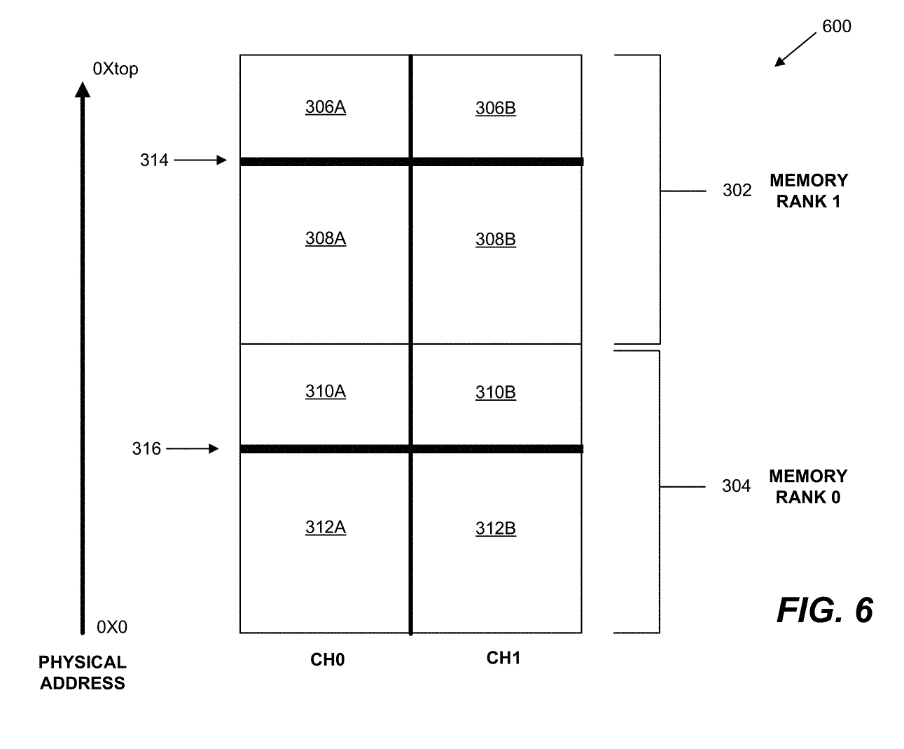

It should be appreciated that the memory allocation schemes described above may be extended to a dual channel embodiment. FIG. 6 illustrates an exemplary memory address map 600 for a dual channel embodiment. In this embodiment, the I/O interface selection may be independent on each channel (i.e., channel 0 (CH0) and channel 1 (CH1)) if channel interleaving is not used. One of ordinary skill in the art will appreciate that channel interleaving may be performed in alternative embodiments. When channel interleaving is used, the same region in different channels, for example 306A on CH0 and 306B on CH1, may use the same interface, both serial interfaces, or both parallel interfaces. When channel interleaving is not used, CH0 may use the serial interface 128 while CH1 uses the parallel interface 130.

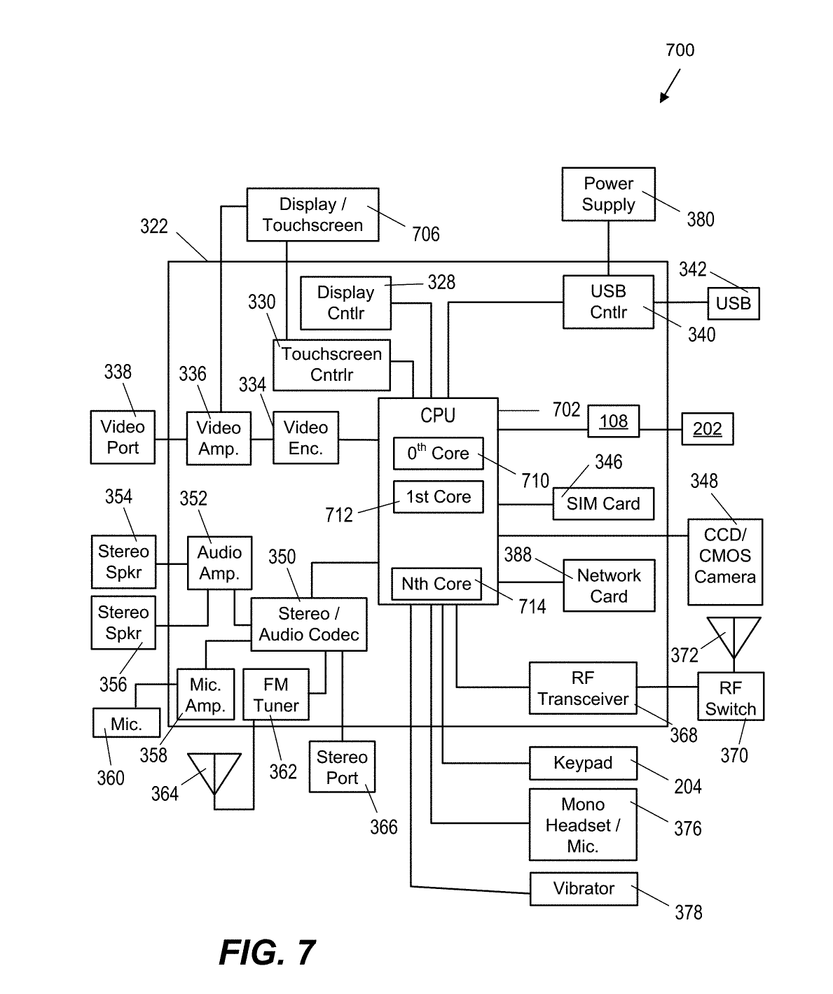

As mentioned above, the system 100 may be incorporated into any desirable computing system. FIG. 7 illustrates the system 100 incorporated in an exemplary portable computing device (PCD) 700. It will be readily appreciated that certain components of the system 100 (e.g., cache 120, cache controller 114, DRAM controller 116) are included on the SoC 322 (FIG. 7) while other components (e.g., the DRAM 104) are external components coupled to the SoC 322. The SoC 322 may include a multicore CPU 702. The multicore CPU 702 may include a zeroth core 710, a first core 712, and an Nth core 714. One of the cores may comprise, for example, a graphics processing unit (GPU) with one or more of the others comprising the CPU.

A display controller 328 and a touch screen controller 330 may be coupled to the CPU 1602. In turn, the touch screen display 706 external to the on-chip system 322 may be coupled to the display controller 328 and the touch screen controller 330.

FIG. 7 further shows that a video encoder 334, e.g., a phase alternating line (PAL) encoder, a sequential color a memoire (SECAM) encoder, or a national television system(s) committee (NTSC) encoder, is coupled to the multicore CPU 702. Further, a video amplifier 336 is coupled to the video encoder 334 and the touch screen display 606. Also, a video port 338 is coupled to the video amplifier 336. As shown in FIG. 7, a universal serial bus (USB) controller 340 is coupled to the multicore CPU 702. Also, a USB port 342 is coupled to the USB controller 340. Memory 104 and a subscriber identity module (SIM) card 346 may also be coupled to the multicore CPU 702.

Further, as shown in FIG. 7, a digital camera 348 may be coupled to the multicore CPU 702. In an exemplary aspect, the digital camera 348 is a charge-coupled device (CCD) camera or a complementary metal-oxide semiconductor (CMOS) camera.

As further illustrated in FIG. 7, a stereo audio coder-decoder (CODEC) 350 may be coupled to the multicore CPU 702. Moreover, an audio amplifier 352 may be coupled to the stereo audio CODEC 350. In an exemplary aspect, a first stereo speaker 354 and a second stereo speaker 356 are coupled to the audio amplifier 352. FIG. 7 shows that a microphone amplifier 358 may be also coupled to the stereo audio CODEC 350. Additionally, a microphone 360 may be coupled to the microphone amplifier 358. In a particular aspect, a frequency modulation (FM) radio tuner 362 may be coupled to the stereo audio CODEC 350. Also, an FM antenna 364 is coupled to the FM radio tuner 362. Further, stereo headphones 366 may be coupled to the stereo audio CODEC 350.

FIG. 7 further illustrates that a radio frequency (RF) transceiver 368 may be coupled to the multicore CPU 7. An RF switch 370 may be coupled to the RF transceiver 368 and an RF antenna 372. A keypad 204 may be coupled to the multicore CPU 702. Also, a mono headset with a microphone 376 may be coupled to the multicore CPU 702. Further, a vibrator device 378 may be coupled to the multicore CPU 702.

FIG. 7 also shows that a power supply 380 may be coupled to the on-chip system 322. In a particular aspect, the power supply 380 is a direct current (DC) power supply that provides power to the various components of the PCD 600 that require power. Further, in a particular aspect, the power supply is a rechargeable DC battery or a DC power supply that is derived from an alternating current (AC) to DC transformer that is connected to an AC power source.

FIG. 7 further indicates that the PCD 700 may also include a network card 388 that may be used to access a data network, e.g., a local area network, a personal area network, or any other network. The network card 388 may be a Bluetooth network card, a WiFi network card, a personal area network (PAN) card, a personal area network ultra-low-power technology (PeANUT) network card, a television/cable/satellite tuner, or any other network card well known in the art. Further, the network card 388 may be incorporated into a chip, i.e., the network card 388 may be a full solution in a chip, and may not be a separate network card 388.

As depicted in FIG. 7, the touch screen display 706, the video port 338, the USB port 342, the camera 348, the first stereo speaker 354, the second stereo speaker 356, the microphone 360, the FM antenna 364, the stereo headphones 366, the RF switch 370, the RF antenna 372, the keypad 374, the mono headset 376, the vibrator 378, and the power supply 380 may be external to the on-chip system 322.

It should be appreciated that one or more of the method steps described herein may be stored in the memory as computer program instructions, such as the modules described above. These instructions may be executed by any suitable processor in combination or in concert with the corresponding module to perform the methods described herein.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, NAND flash, NOR flash, M-RAM, P-RAM, R-RAM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for allocating memory in a hybrid parallel/serial memory system, the method comprising:
configuring a memory address map for a multi-rank memory system with a dedicated serial access region in a first memory rank and a dedicated parallel access region in a second memory rank;
receiving a request for a virtual memory page; and
if the request comprises a performance hint, selectively assigning the virtual memory page to a free physical page in the dedicated serial access in the first memory rank and the dedicated parallel access region in the second memory rank.

2. The method of claim 1, wherein the multi-rank memory system comprises a multi-rank dual inline memory module (DIMM) electrically coupled to a system on chip (SoC).

3. The method of claim 1, wherein the multi-rank memory system comprises a dynamic random access memory (DRAM).

4. The method of claim 1, wherein the serial access comprises a high-speed serial expansion bus, and the parallel access comprises a double data rate (DDR) bus.

5. The method of claim 1, wherein the memory address map comprises an additional dedicated parallel access region in one or more of the first and second memory ranks.

6. The method of claim 5, further comprising:
if the request does not comprise the performance hint, allocating the request to the additional dedicated parallel access region.

7. The method of claim 1, wherein the selectively assigning the virtual memory page to the free physical page in the serial access region and the parallel access region comprises:
determining one of the dedicated serial access region and the dedicated parallel access region is currently being accessed by a previous request; and
assigning the virtual memory page to the free physical in the other of the dedicated serial access region and the dedicated parallel access region to avoid a memory collision.

8. The method of claim 1, wherein the performance hint comprises a kernel flag.

9. A system for allocating memory in a hybrid parallel/serial memory system, the method comprising:
means for configuring a memory address map for a multi-rank memory system with a dedicated serial access region in a first memory rank and a dedicated parallel access region in a second memory rank;
means for receiving a request for a virtual memory page; and
means for selectively assigning the virtual memory page to a free physical page in the dedicated serial access in the first memory rank and the dedicated parallel access region in the second memory rank if the request comprises a performance hint.

10. The system of claim 9, wherein the multi-rank memory system comprises a multi-rank dual inline memory module (DIMM) electrically coupled to a system on chip (SoC).

11. The system of claim 9, wherein the multi-rank memory system comprises a dynamic random access memory (DRAM).

12. The system of claim 9, wherein the serial access comprises a high-speed serial expansion bus, and the parallel access comprises a double data rate (DDR) bus.

13. The system of claim 9, wherein the memory address map comprises an additional dedicated parallel access region in one or more of the first and second memory ranks.

14. The system of claim 13, further comprising:
means for allocating the request to the additional dedicated parallel access region if the request does not comprise the performance hint.

15. The system of claim 9, wherein the means for selectively assigning the virtual memory page to the free physical page in the serial access region and the parallel access region comprises:
means for determining one of the dedicated serial access region and the dedicated parallel access region is currently being accessed by a previous request; and
means for assigning the virtual memory page to the free physical in the other of the dedicated serial access region and the dedicated parallel access region to avoid a memory collision.

16. The system of claim 9, wherein the performance hint comprises a kernel flag.

17. A system for allocating memory in a hybrid parallel/serial memory system, the system comprising:
a multi-rank memory system comprising a first memory rank and a second memory rank; and
a system on chip (SoC) electrically coupled to the multi-rank memory system via a serial bus and a parallel bus, the SoC comprising a memory allocator configured to: receive a request for a virtual memory page; and if the request comprises a performance hint, selectively allocate the virtual memory page to a free physical page in a dedicated serial access region in the first memory rank and a dedicated parallel access region in the second memory rank.

18. The system of claim 17, wherein the multi-rank memory system comprises a multi-rank dynamic random access memory (DRAM) dual inline memory module (DIMM).

19. The system of claim 17, wherein the serial bus comprises a high-speed serial expansion bus, and the parallel bus comprises a double data rate (DDR) bus.

20. The system of claim 17, wherein the selectively allocating the virtual memory page to the free physical page in the dedicated serial access region in the first memory rank and the dedicated parallel access region in the second memory rank comprises:
determining one of the dedicated serial access region and the dedicated parallel access region is currently being accessed by a previous request; and
assigning the virtual memory page to the free physical in the other of the dedicated serial access region and the dedicated parallel access region to avoid a memory collision.

21. The system of claim 17, wherein the performance hint comprises a kernel flag.

22. A computer program embodied in a memory and executable by a processor for allocating memory in a hybrid parallel/serial memory system, the computer program comprising logic configured to:
partition a memory address map for a multi-rank memory system with a dedicated serial access region in a first memory rank and a dedicated parallel access region in a second memory rank;
receive a request for a virtual memory page; and
if the request comprises a performance hint, selectively assign the virtual memory page to a free physical page in the dedicated serial access in the first memory rank and the dedicated parallel access region in the second memory rank.

23. The computer program of claim 22, wherein the multi-rank memory system comprises a multi-rank dual inline memory module (DIMM) electrically coupled to a system on chip (SoC).

24. The computer program of claim 22, wherein the multi-rank memory system comprises a dynamic random access memory (DRAM).

25. The computer program of claim 22, wherein the serial access comprises a high-speed serial expansion bus, and the parallel access comprises a double data rate (DDR) bus.

26. The computer program of claim 22, wherein the memory address map comprises an additional dedicated parallel access region in one or more of the first and second memory ranks.

27. The computer program of claim 26, further comprising logic configured to:
allocate the request to the additional dedicated parallel access region if the request does not comprise the performance hint.

28. The computer program of claim 22, wherein the logic configured to selectively assign the virtual memory page to the free physical page in the serial access region and the parallel access region comprises logic configured to:
determine one of the dedicated serial access region and the dedicated parallel access region is currently being accessed by a previous request; and
assign the virtual memory page to the free physical in the other of the dedicated serial access region and the dedicated parallel access region to avoid a memory collision.

29. The computer program of claim 22, wherein the performance hint comprises a kernel flag.

30. The computer program of claim 22, incorporated in a portable communication device.
